(19) United States
(12) Patent Application Publication
(10) Pub. No.: US 2024/0083080 A1
(43) Pub. Date: Mar. 14, 2024

(54) WOOD-PLASTIC HYBRID COMPONENT

(71) Applicant: Dr. Ing. h.c. F. Porsche Aktiengesellschaft, Stuttgart (DE)

(72) Inventors: Philipp Kellner, Renningen-Malmsheim (DE); Scally Rommelfanger, Bad Liebenzell (DE); David Schmidt, Bühl (DE)

(73) Assignee: Dr. Ing. h.c. F. Porsche Aktiengesellschaft, Stuttgart (DE)

(21) Appl. No.: 18/224,133

(22) Filed: Jul. 20, 2023

(30) Foreign Application Priority Data
Sep. 8, 2022 (DE) 10 2022 122 808.8

(51) Int. Cl. B29C 45/14

(52) U.S. Cl. CPC B29C 45/14336; B29K 2711/14

(57) ABSTRACT

A wood-plastic hybrid component includes a wood part and a form-fit plastic part. The wood part includes a structural zone having a machine-deformed and closed surface structuring with machined recesses. The plastic part includes a form-fitting zone with elevations that engage into the complementary recesses of the surface structuring, such that a full-surface form fit is realized in the transverse direction in relation to the recesses.

### CROSS-REFERENCE TO RELATED APPLICATION

This application claims priority to German Patent Application No. 10 2022 122 808.8, filed Sep. 8, 2022, the content of such application being incorporated by reference herein in its entirety.

### FIELD OF THE INVENTION

The invention relates to a wood-plastic hybrid component, which is preferably used in vehicle construction.

### BACKGROUND OF THE INVENTION

In vehicle construction, there is a fundamental need to produce components from raw materials that are as sustainable as possible, and in particular to replace plastic components with components made of a sustainable raw material. Wood is a sustainable raw material. In vehicle construction, pure wood components often cannot provide the necessary complex structures. By contrast, wood-plastic hybrid components can be suitable for replacing pure plastic components in order to thereby reduce the plastic use. The laminar and structurally simple component can be represented by the wood component, whereas the structurally complex component can be represented by the plastic component.

Such a wood-plastic hybrid component for vehicle construction is known from DE 10 2019 131 625 A1, which is incorporated by reference herein. Here, the plastic component grips the edge region of the wood component in a clip-like manner in order to fix the plastic part to the wood part. However, because plastic and wood are unrelated materials, a permanently high-strength, material bonding is not possible, for example through adhesion. Such a hybrid component therefore cannot be considered for high mechanical strength requirements.

By contrast, a problem addressed by the invention is to create a wood-plastic hybrid component for vehicle construction that is suitable for high strength requirements.

### SUMMARY OF THE INVENTION

The wood-plastic hybrid component according to aspects of the invention consists of (or comprises) a wood part and a plastic part connected to the wood part in a form fit. The wood part comprises in an edge region a structural zone having a machine-deformed and closed surface structuring with machined recesses. In the present case, a closed surface structuring is understood to mean a surface structuring that is free of continuous openings through the entire wood part, but rather has exclusively closed recesses. In the present case, surface structuring does not mean a possibly natural surface structuring of the wood part, but rather only a structuring that was generated by machine deformation. The surface structuring is not produced in a chip-lifting manner so that the wood fibers are locally deformed but not cut.

The machine deformation can be created by, for example, knurling, stamping, or structuring rollers, or by integration of a corresponding negative profile into a wood mold tool, etc. The machine deformation can occur at various temperatures and humidities of the tool or the wood part, respectively. However, the wood part is preferably both more humid and warmer than the room climate surrounding the wood part during the machine deformation.

For the wood part, various types of wood are possible, for example beech, oak, spruce, fir, balsa, bamboo, etc. The wood part can be single-layered, but it can also be multi-layered.

The plastic part in turn has a form-fitting zone with elevations that are complementary to the wood part recesses, which engage into the wood part recesses such that a form fit over a large surface area in the transverse direction in relation to the recesses is realized. In principle, the plastic part can already be manufactured before assembly with the wood part, and the form-fitting zone can have complementary elevations to the wood part recesses. Preferably, however, the plastic part with its form-fitting zone is produced by an injection molding process in which the structural zone of the wood part has been loaded into the injection mold and the form-fitting zone of the plastic part is directly sprayed at the wood part structural zone.

A thermoplastic, preferably polypropylene, polyamide, or a biopolymer, is particularly suitable as the plastic. The plastic part can be formed unreinforced, but is preferably formed in a reinforced fashion, in particular short fiber-reinforced, long fiber-reinforced, or continuous fiber-reinforced. The reinforcing fibers can be made of carbon fibers, aramid fibers, glass fibers, basalt fibers, natural fibers, or plant fibers.

Preferably, the recesses of the surface structuring of the wood part describe a regular pattern.

Preferably, the wood part is formed from a panel-shaped wood body and the structural zone is formed over the full surface in a wood body edge region. The wood body edge region can have a lower material thickness in the region of the structural zone than outside the structural zone. Thus, the structural zone of the wood part can be compressed opposite the adjacent non-structured zone of the wood part.

Preferably, the wood part in the region of the surface structuring is made of solid wood.

Preferably, the structural zone is at least 10% larger than the form-fitting zone in terms of area, so that it is always ensured that the entire surface of the plastic part, which is immediately adjacent to the wood part, is used for the form-fitting.

It is preferably provided that the recesses have a depth that is at most 15% of the total material thickness of the wood part in the region of the structural zone. If a structural zone is respectively provided on both sides of the wood part, the sum of the total depth of the recesses of both sides should be a maximum of 25% of the maximum material thickness of the wood part in the region outside the structural zone. In this way, it is ensured that the compression of the wood part in the region of the structural zone is always so low that the wood part in this region is not too mechanically weakened by the machine-generation of the recesses.

Preferably, the wood part is formed from a panel-shaped wood body, and the structural zone is formed over the full surface in the wood body edge region. In the present case, it is understood that the structural zone extends over the entire width of the relevant edge region and the surface structure is not merely partially provided in the edge region.

Preferably, in the region of the form-fitting zone, there is no material bond between the wood part and the plastic part, in particular, the wood part and the plastic part are not adhered to one another in this region.

Particularly preferably, the wood-plastic hybrid component according to aspects of the invention is a semi-finished product, which is machined by means of a corresponding, in particular material-lifting, machining, in order to create a functional component from the semi-finished product, for example for a motor vehicle.

### BRIEF DESCRIPTION OF THE DRAWINGS

An exemplary embodiment of the invention will be explained in further detail in the following with reference to the drawings. The figures show:

FIG. 1 a wood-plastic hybrid component according to aspects of the invention in a perspective view consisting of a wood part and a plastic part,

FIG. 2 a cross-section of the wood-plastic hybrid component of FIG. 1 in the region of the connection between the wood part and the plastic part, and

FIGS. 3a, 3b, and 3c the wood part of FIGS. 1 and 2 with differently designed structural zones.

### DETAILED DESCRIPTION OF THE INVENTION

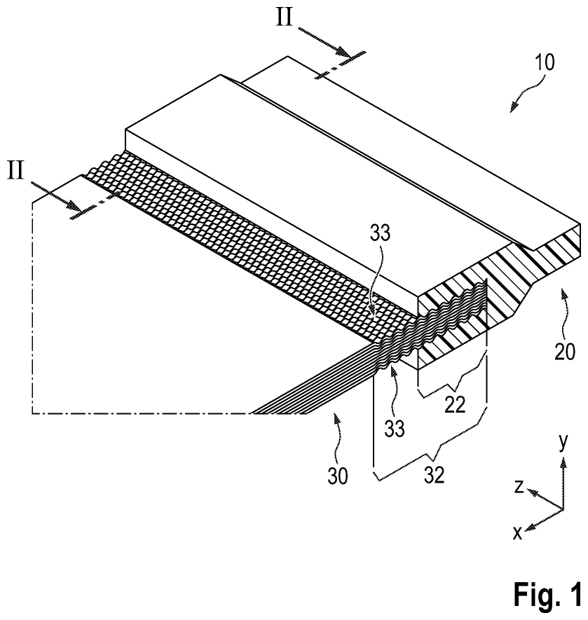

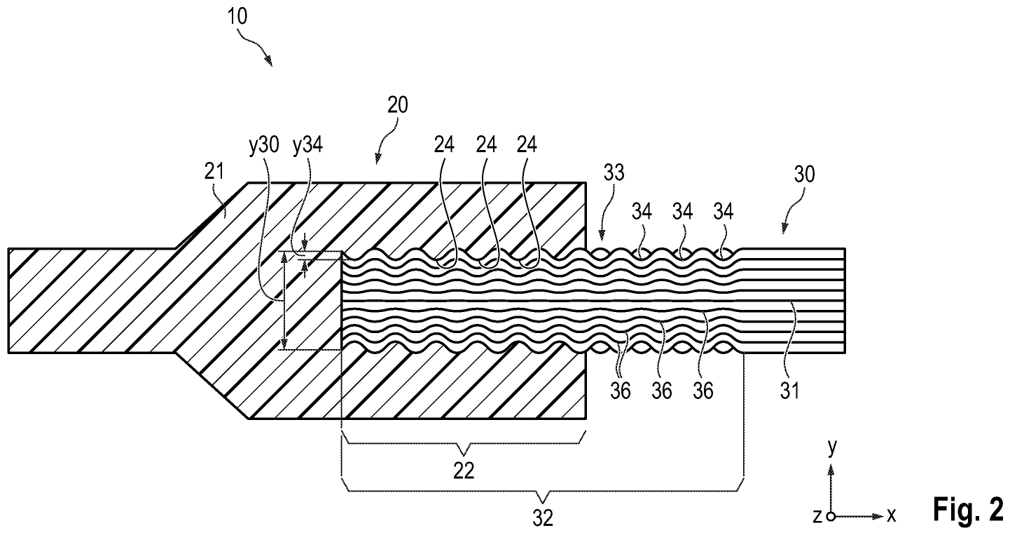

FIGS. 1 and 2 show a part of a wood-plastic hybrid component 10, which in the present case is a semi-finished product for the manufacture of a component of a motor vehicle. The hybrid component 10 consists of a board-like wood part 30 and a plastic part 20 connected thereto in a form-fitting manner.

The rectangular wood part 30 is formed from a wood body 31 made of solid wood, for example beech, oak, spruce, pine, balsa, or bamboo wood.

The plastic part 20 consists of an integral plastic body 21, which is fork-like when viewed in a cross-sectional plane XY and comprises two fork arms. The plastic body 21 is made of a thermoplastic, for example polypropylene, polyamide, or a biopolymer. The plastic portion 20 can be short fiber-reinforced, long fiber-reinforced, or continuous fiber-reinforced. In particular, carbon fibers, aramid fibers, glass fibers, basalt fibers, or natural fibers are considered as reinforcing fibers.

The edge strip or edge region of the wood part 30 has a structural zone 32 which has an exclusively machined and closed surface structuring 33 with machined recesses 34. The surface structuring 33 can be produced by, for example, knurling, stamping, or structural rolling.

The plastic part 20 comprises a corresponding fork-shaped form-fitting zone 22, in which the two proximal fork finger sides facing the wood part 30 have elevations 24, which engage into the complementary recesses of the surface structure 33 over the full surface. A laminar form fit is thereby realized on both sides in the edge region of the wood part 30, which acts in the two transverse directions X, Z in relation to the recesses 34. There is no material closure between the wood part 30 and the plastic part 20, in particular in the region of the form-fitting zone 22.

As shown in FIG. 2, the structural zone 32 in the direction of the center of the wood part is approximately 40% larger in area than the corresponding form-fitting zone 22 of the plastic part 20. The recesses 34 on both sides have a depth Y34, which in the present case is approximately 10% of the total material thickness Y30 of the wood part 30 in the region of the structural zone 32.

In order to produce the wood-plastic hybrid component 10, the surface structuring 33 is first machined into the wood part 30 in its peripheral region on both sides, for example by structural rollers. The wood part 30 machined in this manner is then loaded into an injection molding tool, and the injection molding tool is closed. The injection molding process is then carried out, in which the plastic part 20, and in particular the form-fitting zone 22, is formed. After curing of the plastic part 20, the wood-plastic hybrid component is available as a semi-finished product.

Alternatively, the manufacture of the plastic part 20 can also be carried out by pressing a pressable plastic semi-finished product.

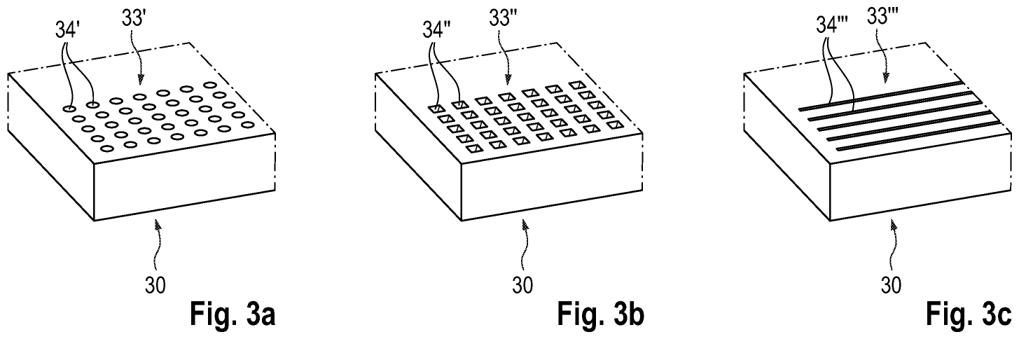

FIGS. 3a, 3b, and 3c show a wood part 30, in each case with an alternative surface structuring 33′, 33″, 33′″: In FIG. 3a, the surface structuring 33′ is formed substantially by spherical recesses 34′. In FIG. 3b, the surface structuring 33″ is formed substantially by rectangular or pyramidal recesses 34″. In FIG. 3c, the surface patterning 33′ is formed by grooved recesses 34′ that are substantially parallel to one another, wherein the longitudinal directions of the grooved recesses 34′ extend approximately parallel to the adjacent edge of the wood part 30.

What is claimed is:

1. A wood-plastic hybrid component comprising:
a wood part including a structural zone having a machine-deformed and closed surface structuring with machined recesses, and
a plastic part including a form-fitting zone with elevations that engage into the machined recesses of the surface structuring, such that a full-surface form fit is realized in a transverse direction in relation to the recesses.

2. The wood-plastic hybrid component according to claim 1, wherein the recesses have a pattern.

3. The wood-plastic hybrid component according to claim 1, wherein the recesses have a depth that is at most 15% of a material thickness of the wood part in a region of the structural zone.

4. The wood-plastic hybrid component according to claim 1, wherein the wood part is formed from a panel-shaped wood body, and the structural zone is formed over a full surface in a wood body edge region.

5. The wood-plastic hybrid component according to claim 1, wherein the wood part in a region of surface structuring is made of solid wood, and the surface structuring is not manufactured in a material-lifting manner.

6. The wood-plastic hybrid component according to claim 1, wherein the structural zone is at least 10% larger than the form-fitting zone.

7. The wood-plastic hybrid component according to claim 1, wherein, in a region of the form-fitting zone, there is no material bonding between the wood part and the plastic part.

8. The wood-plastic hybrid component according to claim 1, wherein the wood-plastic hybrid component is a semi-finished product.

9. The wood-plastic hybrid component according to claim 1, wherein structural zone is disposed in an edge region on both sides of the wood part, which structural zone is form-fit on both sides of the wood part with corresponding form-fitting zones by the plastic part, wherein the wood part additionally comprises through-holes that are filled with the plastic part so that both form-fitting zones of the plastic part are materially bonded.

10. The wood-plastic hybrid component according to claim 1 consisting of the wood part and the form-fit plastic part.

11. A method for manufacturing a wood-plastic hybrid component comprising (i) a wood part including a structural zone having a closed surface structuring with recesses, and (ii) a plastic part including a form-fitting zone with elevations that engage into the recesses of the closed surface structuring, such that a full-surface form fit is realized in a transverse direction in relation to the recesses, said method including the following steps:
a. providing at least one wood semi-finished product,
b. introducing recesses into the wood semi-finished product for creating the wood part,
c. loading the wood part into an injection molding or pressing tool, and
d. manufacturing the plastic part by either an injection molding process or pressing process.

12. The method according to claim 11, wherein the recesses are formed by knurling with a roller or by a pressure punch in an on-off tool.
